(19) United States
(12) Patent Application Publication
(10) Pub. No.: US 2002/0063202 A1
(43) Pub. Date: May 30, 2002

(54) Multiple state opto-electronic switch

(76) Inventors: Ralph E. Simon, Cupertino, CA (US); Thierry Hernoult, Cupertino, CA (US); Livio Lascu, Sunnyvale, CA (US)

Correspondence Address: N.R.H. Black, SKJERVEN MORRILL MacPHERSON LLP, Suite 2800, 3 Embarcadero Center, San Francisco, CA, 95110-1349, US

(21) Appl. No.: 09/965,361

(22) Filed: Sep. 26, 2001

Related U.S. Application Data
(60) Provisional application No. 60/241,283, filed on Oct. 17, 2000.

(51) Int. Cl. G01D 5/34

(52) U.S. Cl. 250/231.13

(57) ABSTRACT

A multiple state opto-electronic switch, having at least three states, includes a moveable member operable to move over a plurality of discrete positions. The moveable member has a plurality of radiation modulating segments from which a plurality of groups are defined. An emitting source is operable to emit radiation. A plurality of detectors, sensitive to the radiation, are each mounted proximate and in fixed position relative to motion of the movable member. Each of the plurality of discrete positions corresponds to a respective mapping between the plurality of detectors and a selected group of the radiation modulating segments. Each group of radiation modulating segments controls the radiation passing from the emitting source to each of the detectors. The plurality of detectors thereby generates a set of output signals responsive to a position of the moveable member.

### CROSS-REFERENCE TO RELATED APPLICATION

This application claims priority to U.S. provisional application No. 60/241,283 filed Oct. 17, 2000 entitled “Multi-State Optoelectronic Switch.”

### FIELD OF THE INVENTION

This invention generally relates to electrical or electronic switches. This invention more particularly relates to a multiple state opto-electronic switch.

### BACKGROUND OF THE INVENTION

A number of schemes have been previously developed for user controls on devices such as appliances—e.g., washing machines, dryers, ovens, etc. Perhaps the most common in use have been mechanical switches having electrical contacts. Many of these switches include critical electromechanical contacts, which may be unreliable in service and prone to wear. Such switches can also be expensive, especially if quality of materials and workmanship is increased in the pursuit of reliability and extended useful life.

Absolute position encoders using opto-electronics may be used as multi-state switches. Such devices have constraints not applicable to control switches, however, and accommodating those constraints adds to cost and otherwise limits design in ways not relevant for control switches. For example, a common type of rotational absolute position encoder, such as a typical industrial single-track Gray code shaft encoder, may be used. Such an encoder will typically be constructed to permit operation through an entire 360 degrees of rotation (or even include multi-turn counting capability) and is designed, at some cost, to eliminate or mitigate problems arising from metastability in intermediate or transitional switch positions. In contrast, a switch operating, for example, as a control knob typically needs to sweep through only a limited arc, can permit arbitrary angles between setting positions and may have an old mechanical detent or similar mechanism to prevent or inhibit persistence in intermediate positions.

Thus a need exists for switches having lower cost, higher reliability, durability and/or imposing fewer mechanical design constraints than do previously-developed implementations.

### SUMMARY OF THE INVENTION

The opto-electronic switches disclosed herein are more reliable than mechanical switches because they eliminate critical mechanical contacts. In addition, such switches can be smaller and cost less than previously developed switches, including other embodiments of opto-electronic switches.

According to an embodiment of the present invention, a switch is provided having a positional input and a set of binary (two-state) electrical or electronic outputs responsive to the positional input. In one embodiment, the positional input is rotational in accordance with the “control knob” paradigm for everyday appliances.

In an application addressed by the switches according to embodiments of the invention, binary outputs representing a number of states are desired. For an eight-state switch, three binary outputs are required, a 16-state switch requires four binary outputs and a 32-state switch requires five binary outputs. In some situations, the number of required output states is not a power of two, in which case the number of binary outputs may be determined by rounding up to the next integer power of two and then taking the logarithm base two. Thus, for example, if nine states are desired, then four outputs (capable of supporting 16 states) are required. The binary outputs of the switch may be converted to electrical forms (e.g., voltages and currents) to operate the appliance that the switch controls.

Embodiments typically use mechanical position settings to selectively modulate paths between radiation sources (emitters) and detectors. For economy and reliability, preferred embodiments use a single radiation emitter to excite multiple detectors. A single emitter may also be more fail-safe than a multiple emitter arrangement since the switch is less likely to be partly functional in the event of emitter component degradation.

In this disclosure, an exemplary 16-state switch is discussed, although the concepts are applicable to switches with more states or fewer states.

### BRIEF DESCRIPTION OF THE DRAWINGS

Preferred embodiments of the invention are described in detail hereinafter with reference to the accompanying drawings, in which:

FIG. 1a illustrates a frontal view of a multiple state opto-electronic switch, according to an embodiment of the present invention.

FIG. 1b illustrates a side view of the opto-electronic switch of FIG. 1a.

FIGS. 2a and 2b illustrate frontal and side views, respectively, detailing the radiation modulating structures of the switch of FIGS. 1a and 1b, according to an embodiment of the present invention.

FIGS. 3a and 3b illustrate frontal and side views, respectively, detailing the radiation modulating structures of the switch, according to another embodiment of the present invention.

FIGS. 4a and 4b illustrate frontal and side views, respectively, detailing the radiation modulating structures of the switch, according to still another embodiment of the present invention.

FIG. 5 illustrates a frontal view of the switch of FIG. 1a and indicates alphabetic designators of the modulating segments and numeric designators of the detectors.

### DETAILED DESCRIPTION OF PREFERRED EMBODIMENTS

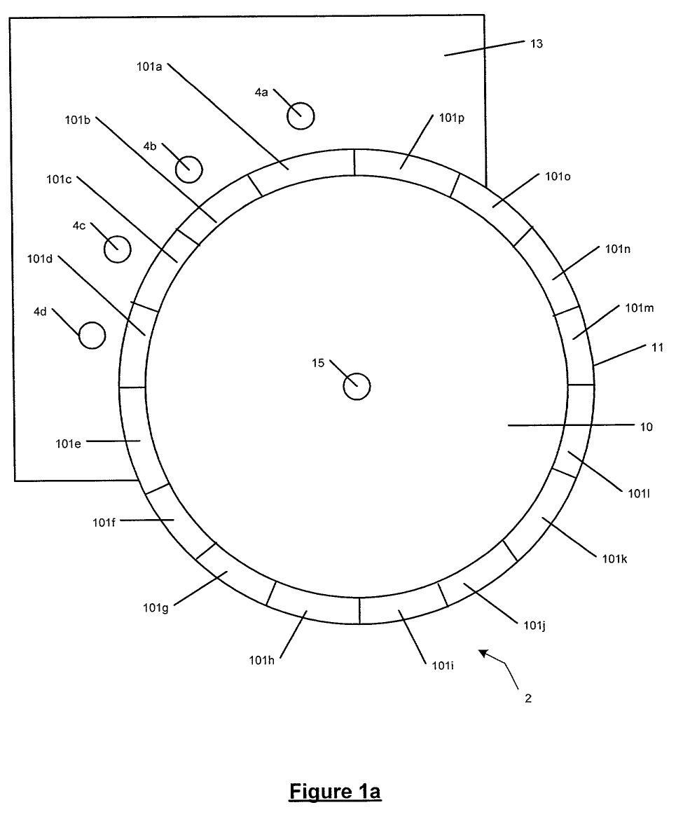

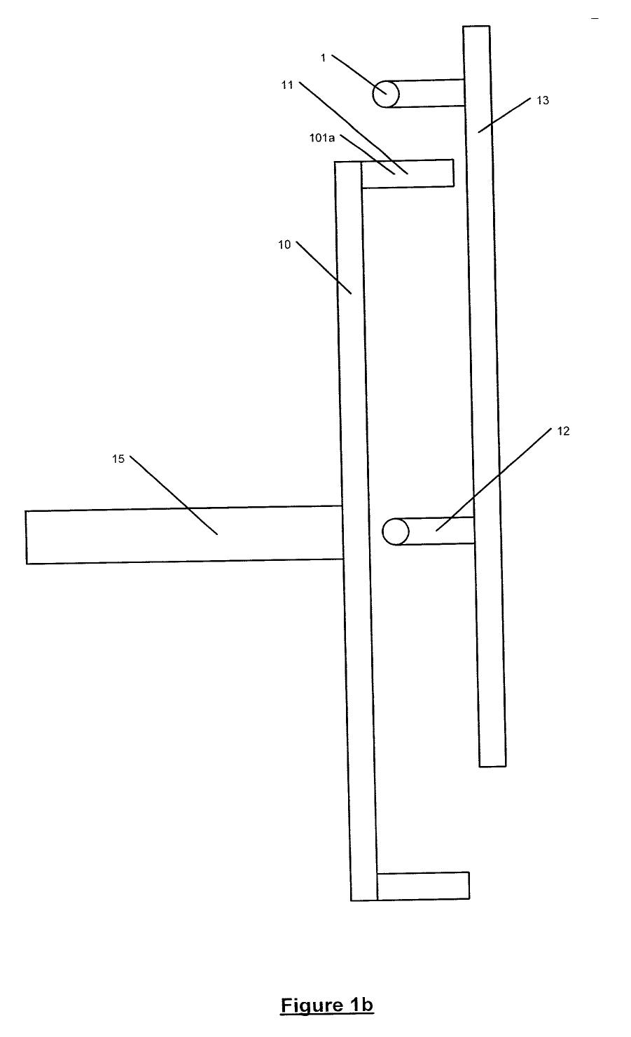

A multiple state opto-electronic switch 2 according to an embodiment of the present invention is shown in FIGS. 1a and 1b. As depicted, switch 2 includes a wheel 10 and a base 13. The wheel 10 features a circular rim 11 shaped as an offset flange, and which has been subdivided into segments 101a, 101b, etc. through 101p. In this embodiment the segments 101a through 101p, collectively, are distributed over the entire circular rim 11 (i.e., 360 degrees). This is not an essential feature, however, and the segments could also, with advantage in some applications, be distributed in an arc of less than 360 degrees. In the present embodiment, each of segments 101a through 101p is either opaque (thereby preventing the passage of light), or transparent or comprise a hole/window (thereby allowing the passage of light). Wheel 10 is rotatably mounted on a support shaft 15 (FIG. 1b). The angular position of the wheel 10 is a physical variable that determines outputs signals generated by switch 2.

Base 13 is provided in fixed relationship relative to the rotatable motion of wheel 10. In one embodiment, base 13 can be a printed circuit board (PCB) which can be connected to appropriate power supply voltage input and ground. PCBs provide stable and low cost platforms for both mounting and for interconnecting electronic, mechanical and electrical components. A number (e.g., four) of sensors (detectors) 4a, 4b, 4c and 4d are mounted on base 13 outside the rim 11 of wheel 10. In one embodiment, the sensors 4a through 4d are placed adjacent at angular intervals equal to the mutual angular offsets of the segments 101a through 101p. In this embodiment, the sensors 4a through 4d are mounted at offsets of 22.5 degrees (i.e., 360/16 degrees). This arrangement allows the sensors 4a through 4d to be mounted in relatively close proximity to one another. As described herein, it is the particular encoding of the segments 101a through 101p (as opaque or transparent/holes) on the rim 11 that make it possible for the sensors 4a through 4d to be mounted in these potentially advantageous adjacent positions. In one embodiment, each sensor 4a through 4d may be “turned on” if it detects light; otherwise, the sensor 4a through 4d may be “turned off.” The sensors in the switches disclosed herein may be optically sensitive transistors but this is not a critical feature. Other sensor technologies, such as Darlington transistors, enhanced contrast transistor sensors and/or binary sensors (e.g., diodes coupled to Schmitt trigger circuits) could be used within the general scope of the invention. And many other sensor technologies known in the arts may be used within the general scope of the invention.

In the present embodiment, a light emitting source 12 provides a source of radiant emission and can be mounted on base 13 at a position proximate the axis of the wheel 10. In one embodiment, light emitting source 12 can be an infrared light emitting diode (LED). Emitters of radiation other than infrared may also be used in cooperation with corresponding sensors. A light emitting source 12 illuminates the sensors 4a through 4d subject to modulation by the segments 101a through 101p on the rim 11. In another embodiment, light emitting source 12 can be mounted on a wheel 10, and many other arrangements are feasible.

Segments (101a through 101p) that are opaque block radiation, whereas segments that are transparent/holes allow radiation to pass from source 12 to one or more of sensors 4a, 4b, 4c and 4d. Thus, in one embodiment, the wheel 10, may be placed in any one of sixteen positions so that a selected group of four segments (any adjacent four of segments 101a through 101p) block or permit radiation to reach sensors 4a, 4b, 4c or 4d. The opaque or translucent property of each segment 101a through 101p determines a binary characteristic or state for that segment. Table 1 illustrates one embodiment for the binary states for segments A through P, generally corresponding to sixteen segments.

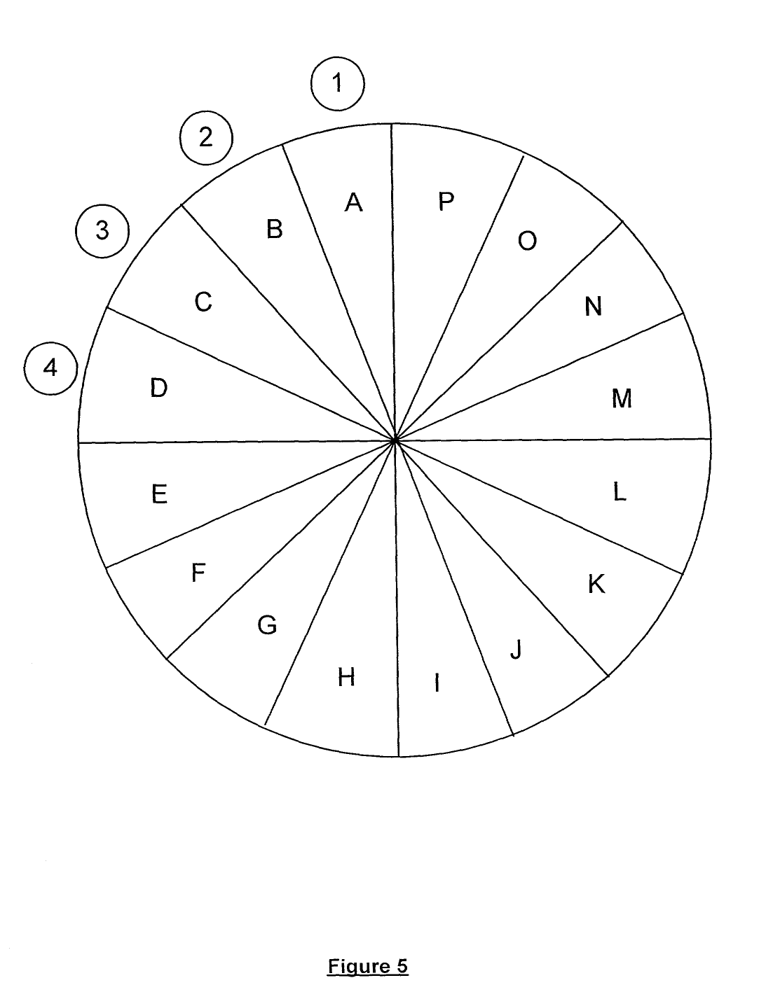

FIG. 5 provides a frontal view of switch 2 with segments 101a through 101p generally labeled by letters A through P, and sensors 4a through 4d generally labeled by numbers 1 through 4. Table 2 provides a mapping between segments A through P and sensors 1 through 4 for various positions of wheel 10. Still referring to FIG. 5, in a first position, segment A is aligned with sensor 1, segment B is aligned with sensor 2, segment C is aligned with sensor 3 and segment D is aligned with sensor 4. This is also shown as wheel position 1 in Table 2 herein, i.e., the first entry in Table 2. In wheel position 1, segment A is aligned with sensor 1 and so the binary encoding as determined by the opaque or translucent property of segment A determines the radiation reaching sensor 1, and thus determines the output of sensor 1.

Provided that a consistent convention is applied, any segment may be encoded opaque or transparent and binary zero may be represented by either polarity of any of a variety of signal types as is well known in the art. In wheel position 1, segments A, B, C and D are aligned with sensors 1, 2, 3 and 4, respectively; in wheel position 2, segments B, C, D, and E are aligned with sensors 1, 2, 3, and 4, respectively; and so on.

Table 3 shows the hexadecimal words produced by sensors 1 through 4 at the 16 positions of the wheel 10 for the binary states assigned to segments A through P in Table 1. Binary values represented by groups of four bits are commonly termed “hexadecimal words” in the art and herein. For example in wheel position 1, Table 2 shows that segments A, B, C and D are aligned with sensors 1, 2, 3, 4, respectively. Table 1 shows that segments A and C are encoded binary 0, whereas segments B and D are encoded binary 1; thus the output of sensors 1, 2, 3, 4 (for wheel position 1) are determined by the encoding of segments A, B, C, and D, respectively. Thus, for wheel position 1, those outputs will be binary 0, 1, 0, 1 respectively equivalent to a hexadecimal word of “0101” or a decimal value of ten. This decimal value is formed by interpreting the four bits of the hexadecimal word as having weights of successive powers of two—i.e., 1, 2, 4, 8. Thus, in the example, ten is calculated as zero times one, plus one times two, plus zero times four, plus one times eight. This set of outputs corresponds to the first entry (row) of Table 3 and the shown successive wheel positions correspond to successive entries of Table 3.

As shown in Table 3, the encoding of segments A through P is arranged so that in each of the sixteen positions of the wheel 10, a unique hexadecimal output word is defined and is represented by each of the four sensors 1 through 4 being turned off or on. Typically a mechanical arrangement will be deployed to ensure that the wheel 10 is held aligned to one of the desired sixteen positions, rather than to any intermediate position or state. Many suitable mechanisms are well known in the mechanical arts.

One aspect of an embodiment of the present invention is the particular placement of the opaque segments on the rim 11 of wheel 10. Referring to FIG. 5, with four sensors, labeled as 1, 2, 3 and 4, and with the wheel having sixteen segments, labeled A through P, the segments will be aligned with the sensors in the sequence shown in Table 2. In one embodiment, a sensor which is conducting current—i.e., one for which radiation is reaching the sensor via a translucent segment—is considered to be “on” or a binary 1; conversely, a sensor for which radiation is blocked by an opaque segment is considered to be a binary 0, With this convention for the wheel segments translucent and opaque as shown in Table 1, the specified binary states will be produced. Circuits and binary values may operate with opposite conventions without loss of utility. In the example cited above, the sensors are placed sequentially in a single quadrant and in close proximity to each other. Alternatively, the sensors can be located in other positions on the perimeter of the circle defined by wheel 10 and achieve a unique set of binary outputs (with a properly configured wheel).

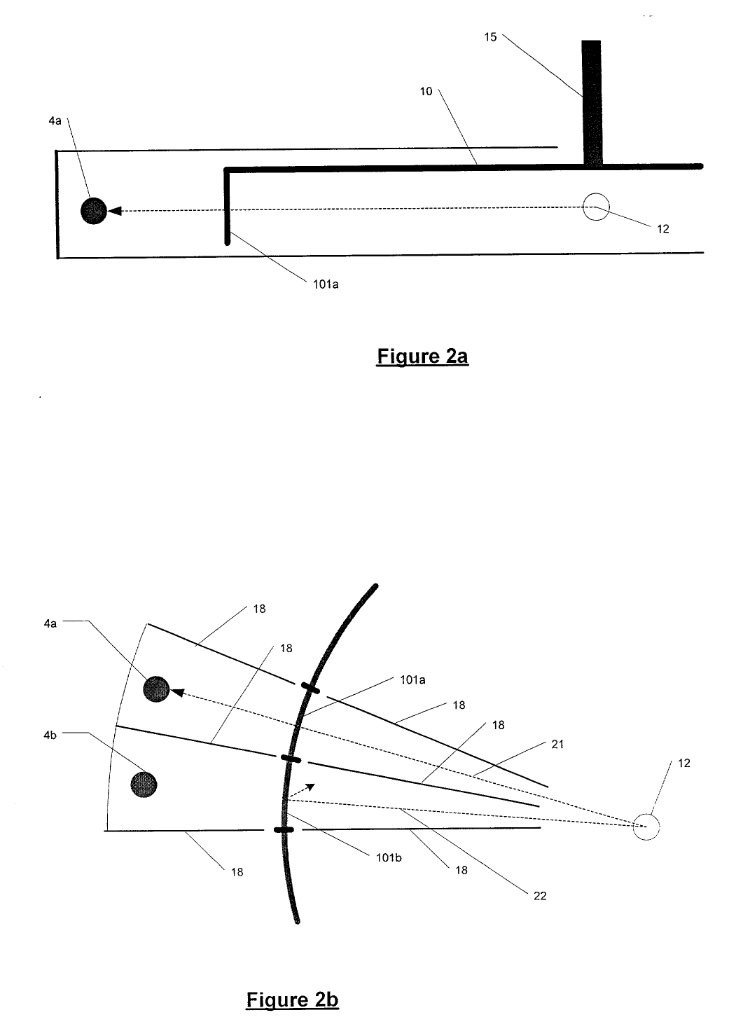

In general as described with reference to FIGS. 1a, 1b, wheel segments can be used to block or allow radiation from reaching the sensor. Several alternative embodiments are shown in FIGS. 2a, 2b, 3a, 3b, 4a and 4b. FIGS. 2a, 2b show plan and elevation views of selected portions of the switch 2 of FIGS. 1a, 1b. In FIGS. 2a, 2b, radiation absorbing walls 18 are provided along radii of the wheel 10. Thus a path 21 taken by radiation emitted from source 12 to sensors 4a, 4b is a simple beam (sensors 4c, 4d are not shown in FIGS. 2a, 2b). The truncation of path 22 shows the effect of opaque segment 101b.

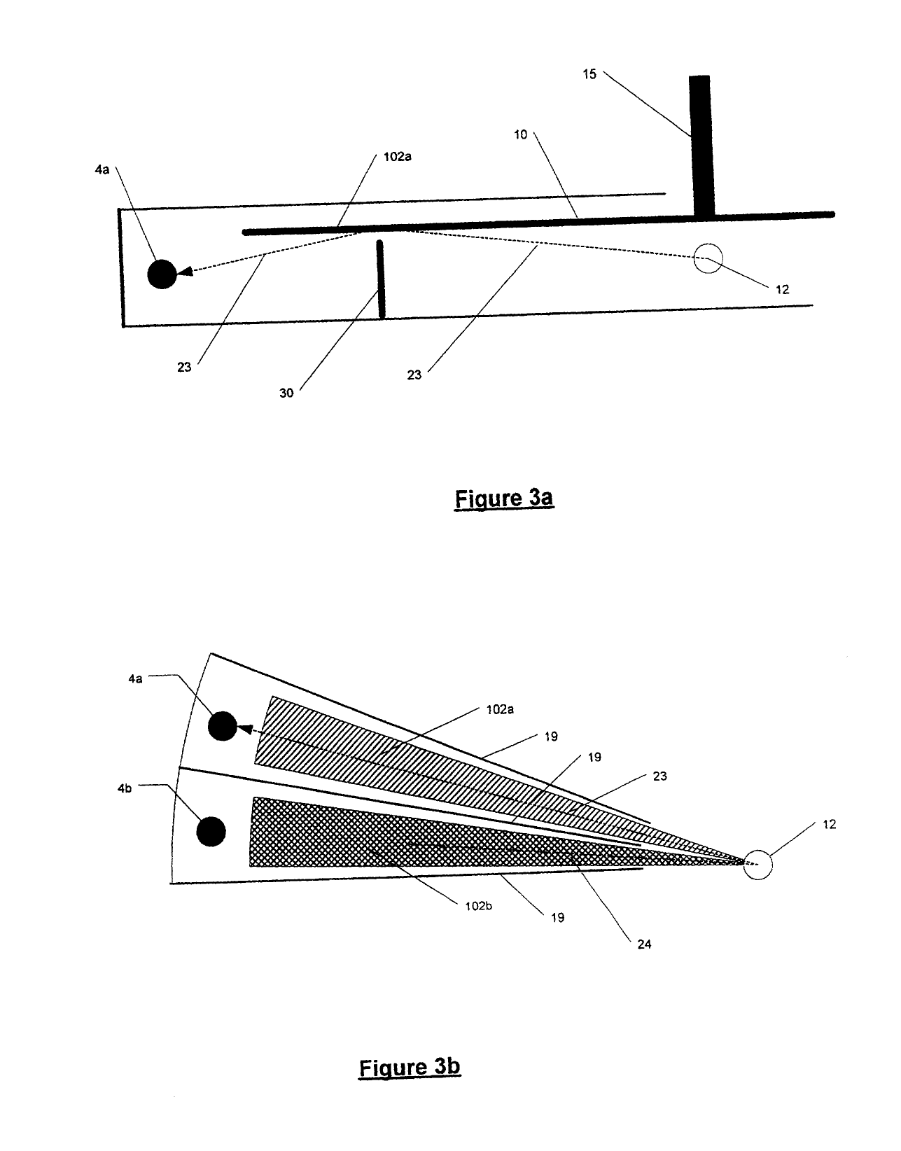

FIGS. 3a, 3b show (in plan and elevation) an embodiment in which a wheel 10 has reflecting and absorbing sectors 102a, 102b, which determine whether more or less radiation reaches each sensor 4a, 4b, etc., thus generating an “on” or “off” state in the sensors. The embodiment of FIGS. 3a, 3b can be implemented with sensor and emitter chips on a PCB base. Still referring to FIGS. 3a, 3b, the radiation passing from source 12 to sensor 4a along a path 23 is reflected by reflecting sector 102a which may typically have a glossy finish. Conversely, radiation absorbing sector 102b may typically have a matte finish and the radiation following path 24 is significantly attenuated. Radiation is inhibited from a direct path by opaque wall 30 and walls 19 prevent or reduce stray radiation.

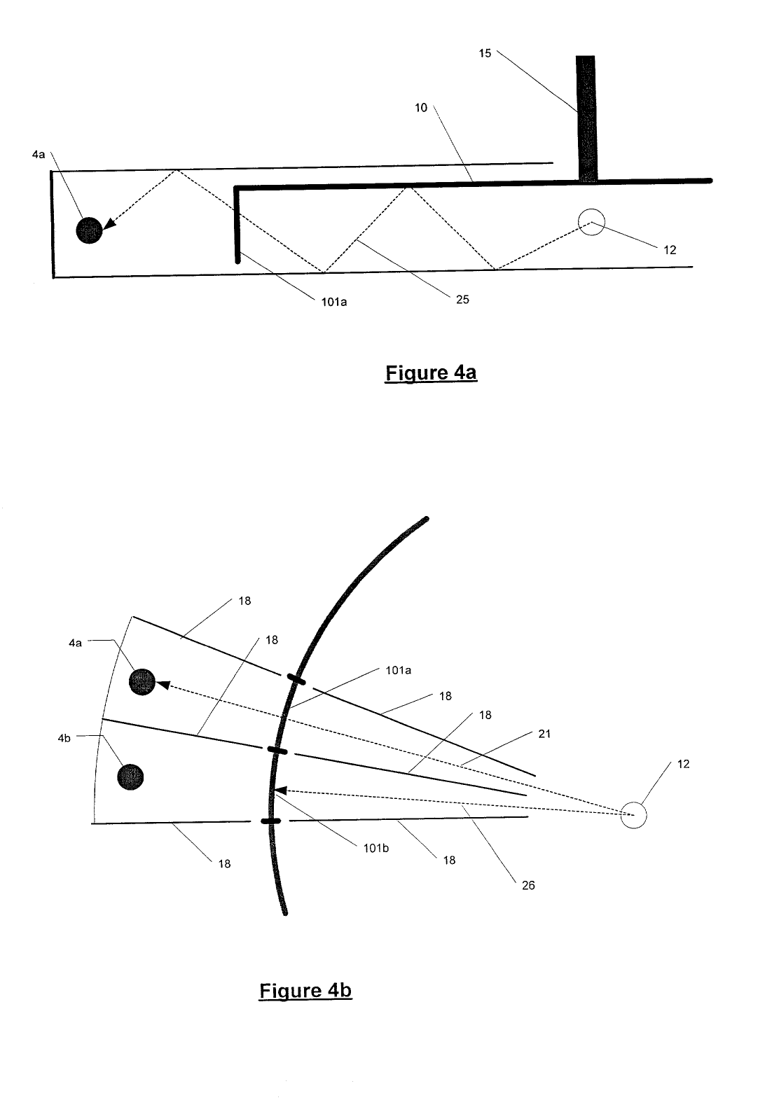

FIGS. 4a, 4b show (in plan and elevation) an embodiment of the switch 2 in which the radiation from source 12 is reflected down the channel, rather than shining directly from the source 12 emitter to the sensors. Possible paths for reflected radiation is shown as beams 25, 26; however, the radiation may typically be scattered and travel along many paths. The embodiment shown in FIGS. 4a, 4b can also be implemented with a chip-on-the-board construction.

Base 13 provides a mounting for amplifiers, decoders, etc., to process and condition the sensor outputs which represent the hexadecimal words reflecting of the contemporary switch position setting. However the inclusion of additional circuitry on the PCB is an economy and a convenient, rather than an essential, feature.

Within the general scope of the invention, other embodiments will be apparent to a person of ordinary skill in the relevant arts. For example modulating segments, can be mounted on a movable member that slides, rather than rotates, in relative motion to the sensors. This would provide mechanical elegance in that the sensors could be arranged linearly. Users may prefer a sliding arrangement to a rotatable control knob in some applications. Another example within the general scope of the invention might involve the use sensors (detectors) that are not radiation based, for example the segments could be implements as magnetic cores and the sensors as inductors. Or Hall effect sensors or many others types may have advantages in particular applications. The invention should be regarded not as limited by the embodiments disclosed but only by the claims herein.

TABLE 1
Binary state for each
segment

| Segment | State |
|---|---|
| A | 0 |
| B | 1 |
| C | 0 |
| D | 1 |
| E | 1 |
| F | 1 |
| G | 1 |
| H | 0 |
| I | 1 |
| J | 0 |
| K | 0 |
| L | 1 |
| M | 1 |
| N | 0 |
| O | 0 |
| P | 0 |

TABLE 2
Segment facing sensor for each
position of the wheel

| | |
|---|---|
| Wheel | Sensor |

| Position | 1 | 2 | 3 | 4 |
|---|---|---|---|---|
| 1 | A | B | C | D |
| 2 | B | C | D | E |
| 3 | C | D | E | F |
| 4 | D | E | F | G |
| 5 | E | F | G | H |
| 6 | F | G | H | I |
| 7 | G | H | I | J |
| 8 | H | I | J | K |
| 9 | I | J | K | L |
| 10 | J | K | L | M |
| 11 | K | L | M | N |
| 12 | L | M | N | O |
| 13 | M | N | 0 | p |
| 14 | N | O | P | A |
| 15 | O | P | A | B |
| 16 | P | A | B | C |

TABLE 3
Binary word state generated at each
position of the wheel.

| Wheel | Binary | Decimal |
|---|---|---|
| Position | State | State |
| 1 | 0101 | 10 |
| 2 | 1011 | 13 |
| 3 | 0111 | 14 |
| 4 | 1111 | 15 |
| 5 | 1110 | 7 |
| 6 | 1101 | 11 |
| 7 | 1010 | 5 |
| 8 | 0100 | 2 |
| 9 | 1001 | 9 |
| 10 | 0011 | 12 |
| 11 | 0110 | 6 |
| 12 | 1100 | 3 |
| 13 | 1000 | 1 |
| 14 | 0000 | 0 |
| 15 | 0001 | 8 |
| 16 | 0010 | 4 |

What is claimed:

1. A switch having at least three states comprising:
a moveable member operable to move over a plurality of discrete positions, the movable member having a plurality of radiation modulating segments from which a plurality of groups are defined;
an emitting source operable to emit radiation; and
a plurality of detectors sensitive to the radiation, each of the detectors being mounted proximate and in fixed position relative to motion of the movable member;
wherein each of the plurality of discrete positions corresponds to a respective mapping between the plurality of detectors and a selected group of the radiation modulating segments, and
wherein each group of radiation modulating segments controls the radiation passing from the emitting source to each of the detectors,
whereby the plurality of detectors generates a set of output signals responsive to a position of the moveable member.

2. The switch of claim 1 wherein radiation modulating is transmissive and each of the radiation modulating segments has a property selected from a list consisting of opaque and transparent.

3. The switch of claim 1 wherein values for the set of outputs signals generated by the plurality of detectors are unique to each of the plurality of discrete positions.

4. The switch of claim 1 wherein the emitting source comprises a light-emitting diode.

5. The switch of claim 1 wherein each of the plurality of detectors comprises an optically sensitive transistor.

6. The switch of claim 1 wherein the plurality of detectors is mounted on a printed circuit board.

7. A switch having at least three states comprising:
a wheel having an axis and operable to move over a plurality of discrete rotational positions, the wheel having a plurality of radiation modulating segments distributed circumferentially thereon at angular offsets, the radiation modulating segments operable to be defined into a plurality of groups;
an emitting source mounted proximate the axis of the wheel and operative to emit radiation; and
a plurality of detectors sensitive to the radiation, each of the detectors being mounted proximate to a circumference of the wheel;
wherein each of the plurality of discrete rotational positions corresponds to a respective mapping between the plurality of detectors and a selected group of the radiation modulating segments, and
wherein each group of radiation modulating segments controls the radiation passing from the emitting source to each of the detectors,
whereby the plurality of detectors generates a set of output signals responsive to a position of the wheel.

8. The switch of claim 7 wherein the plurality of groups of radiation modulating segments implements a single track circumferential encoding.

9. The switch of claim 7 wherein each of the detectors is mounted with mutual angular offsets substantially the same as the angular offsets of each of the plurality of radiation modulating segments.

10. The switch of claim 9 wherein the mutual angular offset between the members of the plurality of radiation modulating segments is not a sub-multiple of three hundred and sixty degrees of arc, and wherein the wheel is constrained to turn in an arc of less than three hundred and sixty degrees.

11. The switch of claim 7 wherein radiation passing from the emitting source to any detector is passed as a beam.

12. The switch of claim 7 wherein radiation passing from the emitting source to any detector is diffused.

13. A switch having at least three states comprising:
a wheel having an axis and operable to move over a plurality of discrete rotational positions, the wheel comprising a plurality of radiation modulating sectors distributed at regular angular offsets, the radiation modulating sectors operable to be defined into a plurality of groups;
an emitting source mounted proximate the axis of the wheel and operative to emit radiation; and
a plurality of detectors sensitive to the radiation, each of the detectors being mounted circumferentially around the wheel;
wherein each of the plurality of discrete rotational positions selects a particular mapping between each of the detectors and a selected group of the radiation modulating sectors, and
wherein each group of the radiation modulating sectors reflects and intensity modulates the radiation passing from the emitting source to each of the detectors,
whereby the plurality of detectors generates a set of output signals responsive to the rotational position of the wheel.

14. The switch of claim 13 wherein the mutual angular offset between the members of the plurality of radiation modulating sectors is substantially the same mutual angular offsets between the members of the plurality of detectors.

15. The switch of claim 13 wherein the mutual angular offset between the members of the plurality of radiation modulating sectors is not a sub-multiple of three hundred and sixty degrees of arc, and wherein the wheel is constrained to turn in an arc of less than three hundred and sixty degrees.

16. The switch of claim 13 wherein values for the set of outputs signals generated by the plurality of detectors are unique to each of the plurality of discrete positions.

17. The switch of claim 13 wherein the emitting source comprises a light-emitting diode.

18. The switch of claim 13 wherein each of the plurality of detectors comprises an optically sensitive transistor.

19. The switch of claim 13 wherein the plurality of detectors is mounted on a printed circuit board.
